(19) United States
(12) Patent Application Publication
(10) Pub. No.: US 2010/0158361 A1
(43) Pub. Date: Jun. 24, 2010

(54) METHOD FOR DETERMINING THE POSITION AND ORIENTATION OF A MEASURING OR REPAIR DEVICE AND A DEVICE WORKING IN ACCORDANCE WITH THE METHOD

(75) Inventors: Helge Grafinger, Salzburg (AT); Christoph Kroell, Kirchberg (AT)

Correspondence Address: BAKER & DANIELS LLP;111 E. WAYNE STREET, SUITE 800, FORT WAYNE, IN, 46802, US

(73) Assignee: REFRACTORY INTELLECTUAL PROPERTY GMBH & CO. KG, Wien (AT)

(21) Appl. No.: 11/814,973

(22) PCT Filed: Mar. 7, 2007
(86) PCT No.: PCT/EP07/01929

§ 371 Date: Sep. 18, 2007

(30) Foreign Application Priority Data
Mar. 22, 2006 (DE) 10 2006 013 185.1

(51) Int. Cl. G06K 9/00; G01B 11/06; G01B 11/14

(52) U.S. Cl. 382/165; 356/630; 356/614

(57) ABSTRACT

A method for the determination of the wall thickness or of the wear and tear of the lining of a metallurgical fusion pot with a scanner system for contactless detection of the lining area with determination of the position and orientation of the scanner system and allocation to the position of the fusion pot by the detection of spatial reference points, characterized by the following procedural steps:
1. Definition of a space coordinate system as a reference system (e.g. perpendicular euclidean three-dimensional coordinate system) by means of at least two measuring fixed points
2. Definition of at least two spatial reference points in the reference system and measuring of these reference points with known geodetic methods
3. Measurement of the coordinates of at least two points of the horizontal or rotational axis of the involved metallurgical container in the reference system with known geodetic methods
4. Definition of a grid system on the developed view of the theoretical interior of the container lining
5. Scanning of the spatial reference points with a three-dimensional scanner (radiation emitting and receiving measuring instrument).
6. Determination of the scanner position in the reference system
7. prior, simultaneous or subsequent scanning of the inner wall of the metallurgical container in the same scanner position as in the case of scanning of the spatial reference points
8. Detection of the pivoting angle of the fusion pot
9. Calculation of the coordinates of each scan point of the interior of the lining in the reference system and allocation of the scan point to a grid element in the grid system defined in Step 4
10. Determination per grid element of a wall thickness or of the wear and tear of the lining using the coordinates of the allocated scan points and coordinates of randomly selectable reference data
11. Representation of the determined wall thickness or of the wear and tear in the grid system

Containers (aggregates) are used in the production of metals, whose jacket of said containers is protected from the high temperatures by a fire-proof lining. Due to mechanical and thermal load and the chemical attack the lining is subject to a permanent wear and tear. This wear and tear must on the one hand be quantitatively detected and on the other hand must be repaired. General scanner systems are used for the quantitative detection, said scanner systems being able to geometrically detect the lining area in a contactless manner in a specified grid. On the basis of the measured geometry of the interior of the lining and comparison with a reference plane areas of wear and tear can be detected and selectively repaired by means of spraying robots. Both systems (detection of the wear and tear, repair of the layer of wear and tear) require for exact operation the precise spatial position and orientation in a higher order coordinate system (reference system).

With the subject matter of DE 198 08 462 C2 a measuring arrangement is known for reference determination of positions of at least 3 reference points and a reference measurement of the lining container.

At least 3 reference points must be arranged in the angular field of view of a CCD camera distributed in space. The disadvantage in this connection is the fact that the presence of 3 reference points in the angular field of view of the camera must be detected simultaneously because only by doing this is the spatial position and orientation of the camera and the wear and tear measuring device attained.

The reference points must therefore be arranged near the container (converter). The disadvantage connected with this is that the reference points could be subject to a wear and tear, covered by smoke and foreign bodies or damaged by the operation of the converter. The arrangement of these reference points near the converter is therefore disadvantageous.

A further disadvantage is the fact that the coordinates of the reference points are placed directly in reference to the coordinates of the container (converter). That is, it is a matter of a permanent, mathematical connection between the coordinates of the container (converter) and the spatial coordinates. However, this is connected with the disadvantage that in the use of a different container (converter) new spatial points are necessary. Thus an expensive new measurement must take place in order to put the converter points in connection with the new spatial points.

A further disadvantage of the named arrangement is the fact that the reference points on the converter side P1 through P4 must each have their own CCD camera assigned. This is a considerable measuring expenditure and a potential source of errors because several CCD cameras must be coordinated with one another.

On the whole the disadvantage of the known arrangement lies in the fact that one is severely restricted in the choice of location of the measuring device. The measuring device must be set up relatively exactly at the position where the reference measurement had taken place. In this connection it is extraordinarily difficult to measure by moving along with the converter, because one requires a defined location in the factory building which must be occupied as precisely as possible over and over again in order to guarantee the repeatability of the measurement.

The named publication is thus based on the disadvantage that with a relatively high measuring expenditure only a relatively poor repeating accuracy can be attained.

In the previously named publications the disadvantage exists in other respects that the site of the measuring arrangement cannot be changed readily with regard to the measuring converter. Often this is however necessary in order to gain a complete insight into all (lateral) angles of the converter.

This is important because one wants to determine the thickness of the layer of wear and tear if at all possible at any random location in the converter. To this purpose it is known to align the measuring arrangement not only centered to the mouthpiece (mouth) of the converter, but rather to also arrange the measuring arrangement slightly to the left or to the right from the center offset to the mouthpiece and measure into the converter in order to detect hidden container areas in the case of a central measurement.

Such an offset, excentric measurement of converter wear and tear layers is not readily possible with the subject matter of EP 0 632 291 B1. If a measurement offset from the center to the left or right is to take place, then the bottom of the converter must also in turn be measured anew in order to redetect the now current position of the bottom-side reference points.

If one wants to perform a central, a left as well as a right measurement on the converter with this measuring system, in the case of an arrangement in accordance with EP 0 632 291 B1 the converter-side reference points on the bottom of the converter must be determined in three different measuring operations. Such a measuring sequence is expensive.

It is true that it is known from US 2004/0056217A1 to determine the position and the orientation of the scanner system and use spatial reference points for this purpose. It is also known from the publication: Foppe, K. et al.: Monitoring of Converters for Steel Production; 9^{th} International Symposium on Deformation Measurements”, Olsztyn (Poland) 1999 to determine the position of a measuring device (tachymeter) with regard to the spatial reference points.

However, how these reference points are to be developed does not follow from these publications. The distance of the measuring device from the floor is always assumed as constant and known in US 2004/0056217A1, a measurement of the distance by the measuring device itself is not contained within. In other respects the named publication requires the use of two separate scanners in combination with three fixed reference points.

DE 102 57 422 A 1 discloses a measuring device with which both the fixed reference points as well as also the container are detected. However, a different method is used for detection of the fixed reference points (detection of linear edges etc.).

Likewise, it cannot be inferred from these publications how the coordinates of the measured points can be converted from one coordinate system to another. However, reference is made to the use of at least three reference points; which in comparison to the two reference points of the present invention is expensive.

With the subject matter of U.S. Pat. No. 5,212,738 A it is known to link two inclination sensors with only three fixed reference points. Two of the reference points (A, B) are fixed to the bottom, while the third reference point (C) is fixed to the container. However, the measuring system has only a severely restricted angular field of view (FOV) which is directed directly to the front in the direction of the converter mouth. Therefore no reference points can be used at the side turned from the container. All reference points are arranged in the region of the container (converter) and with that influenced by smoke, dust etc.

The object of the present invention is to further develop a position determination of a measuring and repair system for metallurgical containers in such a way that a slight measuring expenditure is necessary for position determination and hence an improved relocatability of the detection device is possible, with the objective of being able to easily detect and evaluate even areas that are difficult to see in the metallurgical container. Further the present invention should also make it possible to have the position and orientation of a scanner or of a repair device in a higher order coordinate system (reference system) and with it to the metallurgical fusion pot determined in simpler fashion.

For solution of the posed problem the invention is characterized by a method of the following described manner.

The essential advantages attained with it are:

only two fixed reference points necessary (instead of at least three in the state of the art)

scanning of the reference points and the inner wall executable with the same scanner

position of the scanner can be determined via the results of the measurements performed by this scanner itself.

In the case of the application in the process of the measuring of the lining of a metallurgical fusion pot the following steps of the method are significant features of the invention:
1. Definition of a space coordinate system as a reference system (e.g. perpendicular euclidean three-dimensional coordinate system) by means of at least two measuring fixed points
2. Definition of at least two spatial reference points in the reference system and measuring of these reference points with known geodetic methods
3. Measurement of the coordinates of at least two points of the horizontal or rotational axis of the involved metallurgical container in the reference system with known geodetic methods
4. Definition of a grid system on the developed view of the theoretical interior of the container lining
5. Scanning of the spatial reference points with a three-dimensional scanner (radiation emitting and receiving measuring instrument).
6. Determination of the scanner position in the reference system
7. In regard to Step 5 prior, simultaneous or subsequent scanning of the inner wall of the metallurgical container with the same scanner in the same scanner position as in the case of scanning of the spatial reference points
8. Calculation of the coordinates of each scan point of the interior of the lining in the reference system and allocation of the scan point to a grid element in the grid system defined in Step 4
9. Determination per grid element of a wall thickness or of the wear and tear of the lining using the coordinates of the allocated scan points and coordinates of randomly selectable reference data
10. Representation of the determined wall thickness or of the wear and tear in the grid system

Depending on the operating state of the container or purpose of the measurement the inner wall of the container is the surface of the steel jacket of the container directed inward or the surface (fire side) of the refractory lining directed inward.

In the case of the present invention the reduction to at least two spatial reference points is possible as a result of the fact that a perpendicular reference system is used and the inclinations of two axes of the scanner coordinate system with regard to a horizontal plane are measured by means of inclination sensors. With this the measured data of the scanner can be transformed into a perpendicular coordinate system, the scanner plumb system.

In a preferred embodiment of the present invention provision is further made in a further step that in the first procedural step the aforementioned measurement of a central position of the scanner with regard to the mouthpiece of the metallurgical container takes place and that in a further procedural step a measuring position offset from the center either to the left or to the right is taken and in this connection in turn the measuring method according to the above named procedural steps 5-9 is performed. The measuring positions are specific to the place of installation of the measuring or repair device, from which the reference points and the inner wall of the metallurgical container are detected.

What is advantageous about this embodiment is the fact that even in the measurement of a measuring standpoint offset from the center one does not have to take the degree of tilt of the container into consideration. The degree of tilt can differ from measurement to measurement by several degrees of angle, because these will be determined by an inclination sensor on the metallurgical container. The degree of tilt will be taken into consideration (calculated) in the allocation of the scan points to the grid elements in the grid system.

With the last named embodiment the essential advantage in comparison to the state of the art exists that it is now for the first time possible to be able to perform even a measurement that is offset to the left or right in relation to the mouthpiece of the metallurgical container in simple fashion with a scanner that can be moved about freely in space (i.e. the place of installation of the scanner is, specific to a “central” position, left or right of this “central” position).

The measuring results gained from these offset measuring positions are combinable because they all are specific to the same reference system or in further sequence to the same grid system of the metallurgical container.

In a preferred embodiment of the invention provision is made that the detection of the wall thickness of the lining of the metallurgical container is accomplished by the preparation of a developed view on a virtual plane with a grid superimposed over it. With this the advantage exists that one obtains a grid coordinate system of the entire inner lining of the metallurgical container that is always accessible and is uniquely defined and that one always accesses the same grid system and can perform appropriate corrections even for the allocation and representation of the results of the measurements offset to the left and to the right.

For example, if it was determined in the case of a central measurement that specified lateral regions of the metallurgical container cannot be detected perfectly, a measurement offset to the left and if necessary also offset to the right takes place and all measuring results are then specific to the aforementioned grid system, i.e. allocated to the respective elements of this grid system.

With the given technical teaching in other respects the advantage arises that the previously named spatial reference points now no longer have to be arranged in the proximity of the metallurgical container. They can be arranged in the vertical or horizontal coverage area of the scanner somewhere in space, which is connected with considerable advantages.

A first advantage lies in the fact that the spatial reference points can now be installed outside the range of the disturbances caused by the metallurgical container. They are no longer subject to slag spatter, the appearance of smoke and other contamination. It can even be possible to arrange the spatial reference points at a distance of about 8 to 10 meters or even up to 20 meters away from the metallurgical container.

In this connection one has complete freedom of design. Thus it is critical that according to the invention the stationary reference points must no longer be arranged behind or next to the metallurgical container. With this the further advantage exists that the metallurgical container is in no way disturbed in its cycle of operation and that in particular no reference points must be arranged directly on the steel jacket of the fusion pot or in the steel construction directly surrounding the fusion pot.

Therefore the range of application of the present invention is specific to all metallurgical fusion pots regardless of their purpose. In particular converters, electric furnaces, ladles and suchlike in the steel industry are measured with the present measuring system, but also fusion pots of all types in the nonferrous metal industry.

Thus it is only important that the stationary reference points are located in the measuring range of the scanner, wherein the scanner can definitely be a scanner which measures in the angular sector of 360° or below.

In the case of such a scanner, which works as a rotating scanner, the significant advantage exists that the reference points can also be located at a great distance from the metallurgical container. They are then outside the range of any environmental influences induced by the container and with this a particularly precise measuring result is possible.

Viewed from the converter the reference points can hence be located behind the scanner at spatial positions.

Thus it is only important that the reference points are distributed somewhere in the space, thus exhibiting a mutually spatial distance.

Reference was made initially of the fact that it suffices to use two reference points, however; more reference points can also be used. If there are more than two reference points present, it is possible to do plausibility checks, precision and reliability statements for the correspondence given therewith for the allocation between the scanner plumb system and the reference system. For measuring technology reasons reference areas are used for the detection of the reference points, wherein the design of the reference areas as spheres or spherical bodies is preferred. It is not necessary here to use solid spheres or completely hollow spheres, it is also sufficient to use sphere surfaces e.g. shells of hemispheres or quadrants. The reference point is then the mid point of the imaginary sphere upon which the used sphere surface lies.

Advantageous in the case of the use of such spherical bodies is the fact that the form of the sphere surface is identical from any visual or measuring position. This is a significant advantage compared to the rectangular areas known in the state of the art which could be rotated or tilted, which falsifies considerably the measuring results.

With the method described just now the position of a 3D scanner, thus the coordinates of the origin of the scanner plumb system of this scanner should be able to be measured or calculated in a euclidean, perpendicular, three-dimensional coordinate system (reference system) as well as the horizontal angle between xL-axis of the scanner plumb system and X-axis of this reference system (orientation angle tL).

By orientation hence the rotation of a perpendicular coordinate system around a vertical axis is understood, in order to be able to align the axis of this coordinate system lying in a horizontal plane parallel to the corresponding axis of a perpendicular reference system. The angle of rotation necessary for this alignment of the axes is termed as orientation angle.

With the same method, as described in the subsequent exemplary embodiment, in addition to the position of the scanner and the longitudinal and lateral inclination of the scanner or of a carrier plate of a repair device (e.g. repair vehicle with spray lance) in reference to the horizontal plane of a euclidean perpendicular three-dimensional coordinate system (reference system) also the horizontal angle between the horizontal longitudinal axis xF of this carrier plate rotated in the horizontal plane and the X-axis of the reference system (orientation angle tF) can be measured or calculated. For the determination of this orientation angle tF an additional reference point on the carrier plate is to be installed at the greatest possible distance from the scanner and to be detected by the scanner. If the carrier plate is for example firmly connected to a vehicle or part of the vehicle essentially the following steps are necessary:
1. Definition of a space coordinate system as a reference system (e.g. perpendicular euclidean three-dimensional coordinate system) by means of at least two measuring fixed points
2. Definition of at least two spatial reference points in the reference system and measuring of these reference points with known geodetic methods
3. Measurement of the coordinates of at least two points of the horizontal or rotational axis of the involved metallurgical container in the reference system with known geodetic methods
4. Definition of a vehicle coordinate system as a three-dimensional euclidean coordinate system
5. Definition of a reference point on the carrier plate and measurement of this reference point and position of the scanner in the vehicle coordinate system
6. Scanning of the spatial reference points and of the reference point fixed on the carrier plate with a three-dimensional scanner mounted on the carrier plate (radiation emitting and receiving measuring instrument).
7. Measuring of the inclination of the vehicle coordinate system around the xF or yF axis with regard to a horizontal plane by means of inclination sensors
8. Determination of the scanner position and coordinates of the reference point fixed on the carrier plate in the reference system and from this determination of the orientation angle tF of the carrier plate in the reference system
9. Preparation of the reference of the vehicle coordinate system to the fusion pot in consideration of the measured inclinations as per Step 7 and of the pivoting angle of the fusion pot

In summary the following results are obtained or measured:
1. Coordinates of the origin of the scanner plumb system of a scanner (on the measuring device or the carrier plate on the vehicle) in a reference system
2. Inclination of the scanner coordinate system in relation to the scanner plumb system (AlphaX and Phi0 angles)
3. Inclination of the vehicle coordinate system around the xF axis with regard to a horizontal plane (AlphaXF)
4. Inclination of the vehicle coordinate system around the yF axis with regard to a horizontal plane (Phi0F)
5. Orientation angle tL and tF
6. Pivoting angle of the fusion pot
7. Coordinates of the origin of the vehicle coordinate system in a reference system

Additionally a possible scaling factor of the range finder of the scanner can be determined.

However, the invention is not restricted to the use of a perpendicular, three-dimensional coordinate system. It can be used in similar fashion in a polar coordinate system or a cylinder coordinate system.

All of the information subsequently given is then applicable in similar manner.

In the definition of the reference system for the three-dimensional measuring of reference points and further reference points known geodetic methods are named for the solution of these detailed tasks. By this the use of a total station is understood, with which simultaneously horizontal angle, vertical angle and slant range can be measured by the measuring instrument at target points (spatial polar coordinates). With the help of these polar coordinates to coordinative named points first the position of the measuring instrument (total station) and in further sequence the position of unknown target points are calculated. In the case of redundant measurement plausibility, accuracy and reliability of the calculated coordinates can be determined using compensation algorithms.

By the expression “total station” in a preferred embodiment a theodolite with an allocated distance measuring system is understood, but also other contactless working measuring instruments which lead to the same result. In particular laser measuring instruments and also ultrasound measuring instruments fall into this category.

For the referencing in the preferred embodiment a euclidean, perpendicular, three-dimensional coordinate system (reference system) is created in the environment of the metallurgical container. This takes place as a result of the fact that the coordinate origin is defined at a random place in space and proceeding from this point a distinct horizontal direction is defined which represents the X axis of the reference system. The Y axis then points from the coordinate origin with 90° counter-clockwise with regard to the X axis also in horizontal direction. The Z axis runs from the coordinate origin to a perpendicular straight line upward.

For simpler management of the reestablishment of this coordinate system at least 2 measuring fixed points are defined, signalized (characterized), measured with known geodetic methods by the use of a total station and their 3-D coordinates in the reference system are calculated. With this it is possible in further sequence to measure and to calculate three-dimensional coordinates in the reference system for all necessary objects at any time.

The above named measuring fixed points are stationary cross-link points in space which are measured with a total station and can be used at any time.

The invention will now be explained in greater detail with the help of an exemplary embodiment. Further features and advantages of the invention result from this exemplary embodiment, said features and advantages which should enjoy protection either in unique position or in combination with each other.

The figures show the following:

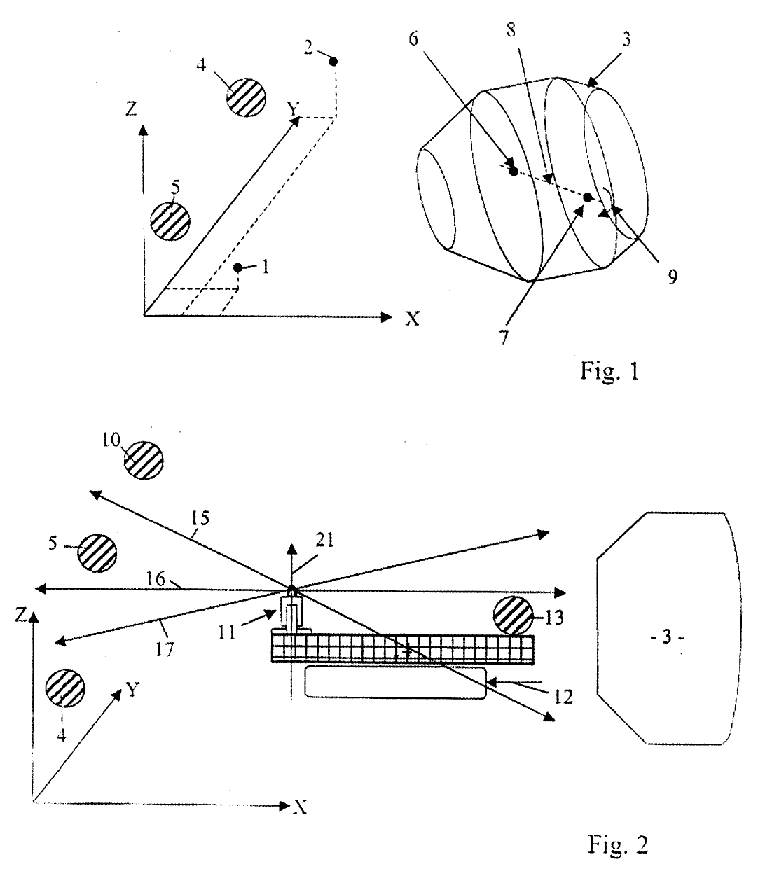

FIG. 1: measuring fixed points, reference points and fusion pot in the reference system with axes X, Y, Z

FIG. 2: diagram of a scanner on a repair vehicle

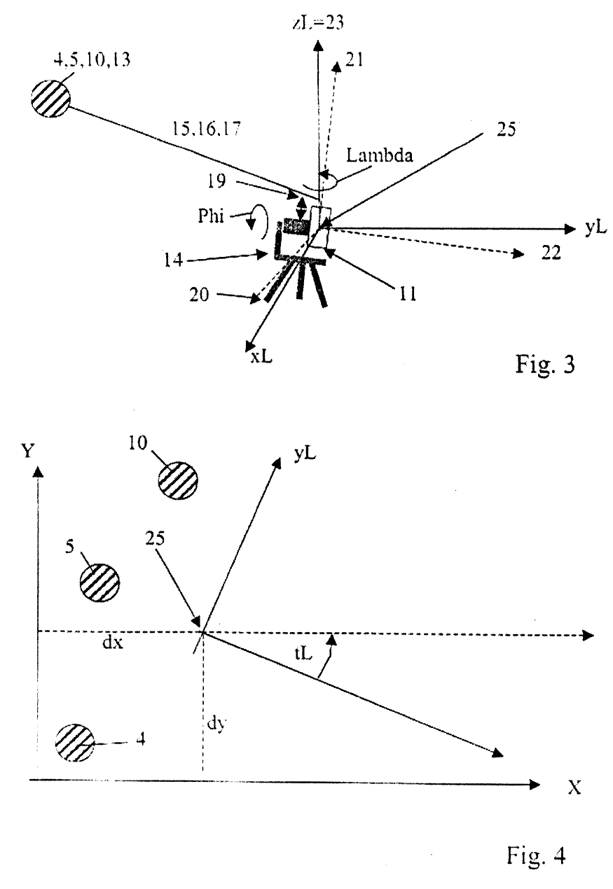

FIG. 3: Axes of the scanner coordinate system and scanner plumb system

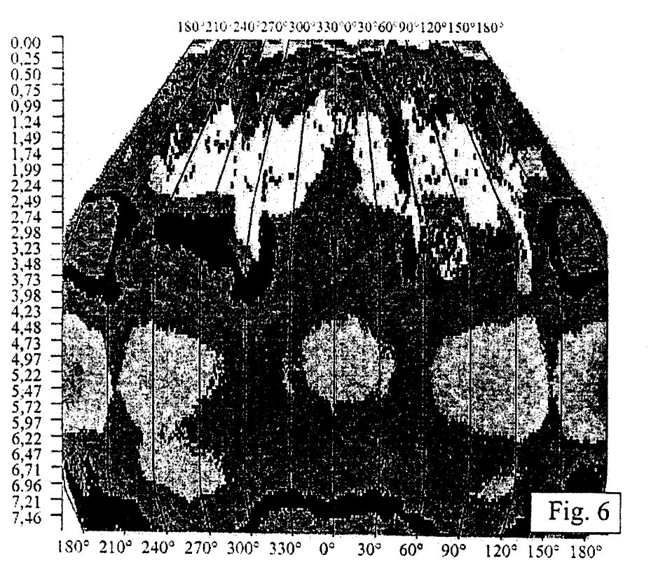

FIG. 4: Position and orientation of the scanner plumb system in the reference system

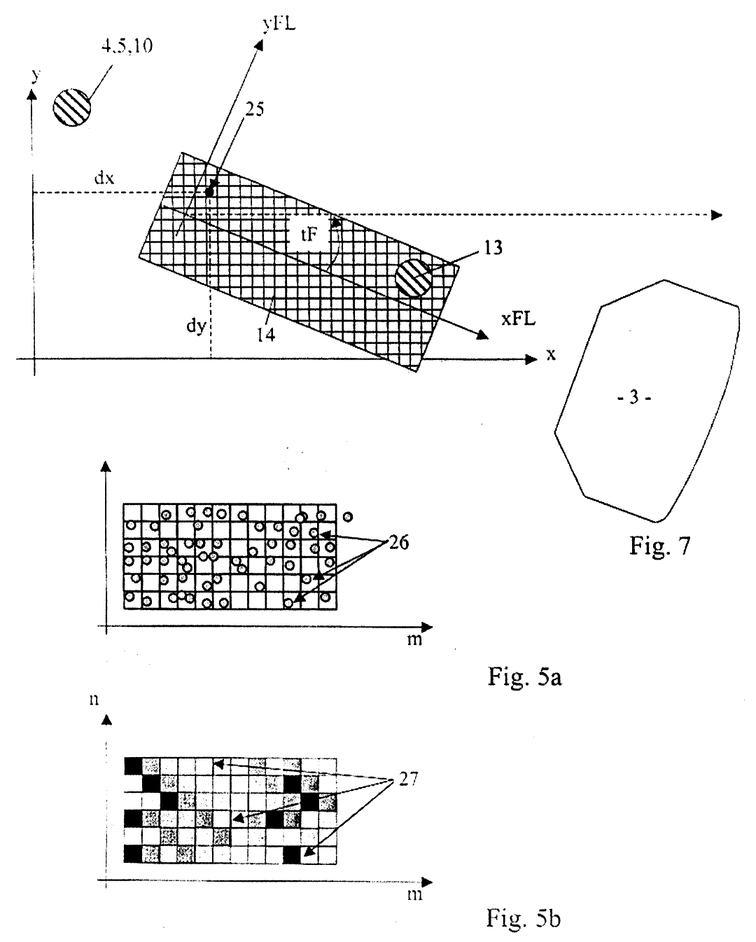

FIG. 5: Section of a developed view of the container inner surface with grid and single scan points and associated gray scale image

FIG. 6: Wear and tear image of a metallurgical container

FIG. 7: Position and orientation of the vehicle coordinate system in the reference system

In FIG. 1 a three-dimensional coordinate system is shown in general form, in which the two spatial and precisely defined measuring fixed points are drawn in. In this connection it is completely arbitrary where the container 3 is arranged. It is only shown in schematic form and can exhibit any random design.

The coordinates of the stationary and precisely defined measuring points 1 and 2 serve the purpose of precise determination of the axes and of the coordinate origin of the reference system and reference points 4 and 5. The reference points are represented by spheres which are easier to detect in measuring technology and are also shown in this manner. The reference point itself is the central point of the respective sphere.

Simultaneously the so-called axis of tilt points 6 and 7 are also defined on the container 3. These axis of tilt points 6 and 7 of the pivoting angle 9 determine the location of the metallurgical fusion pot in the three-dimensional reference system. The two axis of tilt points 6 and 7 define the axis of tilt 8.

The position and spatial location of the metallurgical container as well as any degrees of freedom (inclination, displacement, elevation) are measured and calculated by connection to the reference system with known geodetic methods using a total station. This can be seen from FIG. 1.

The pivoting angle 9 is the angle by which the container is swiveled around its axis of tilt 8. This pivoting angle (angle of inclination) of the fusion pot across from a distinct location (preferably perpendicular position of the container) is detected with an inclination meter installed on the container.

The use of a scanner 11 in accordance with the invention is shown in FIG. 2. The scanner 11 is fastened to a carrier plate 14, upon which a further reference point 13 is fastened, which however is only required when the whole arrangement is part of a repair device for a metallurgical container. In this case the alignment of the carrier plate or the repair device connected to it to the container 3 to be repaired must be uniquely detected. The carrier plate 14 is in this case fastened to the chassis 12 of a repair vehicle.

If on the other hand only a measuring system is embodied, the chassis 12 can be omitted and the carrier plate 14 is fastened to another suitable apparatus which can also shifted in front of the container 3 e.g. in an axis parallel to the axis 8 for performance of the center, left and right measurement. The positions from which the central, left-side or right-side measurement takes place however do not necessarily have to lie on a straight line, but rather can be randomly selected within predefined ranges.

Spheres made of any material are used for reference points 4, 5, 10, 13 for the scanner 11. The size of the spheres goes by the resolution of the scanner being used 11. In general the diameter of the spheres that are used should extend over at least 5 scan points in order in this way to facilitate a detection of the spheres. In the case of a scanning resolution of e.g. 0.25°×0.25° a scan point covers a range of about 4×4 cm at a distance from the scanner of 10 m.

Therefore, in this case a sphere as reference point 4, 5, 10, 13 must exhibit a diameter of at least 20 cm. The reference spheres (4, 5, 10) are to be mounted stationary in the environment of the container in such a way that at least 2 spheres of each measuring position can be detected by the scanner, i.e. must be visible and must lie within the distance range of the scanner 11. The coordinates of the central point of each sphere, thus the coordinates of the reference points are measured and calculated by connection to the reference system with known geodetic methods using a total station and can hence be assumed as known for detection with the scanner. In the case of the usage of a repair vehicle at least one additional reference point must be located on the repair vehicle (chassis 12) or on the carrier plate 14 fastened on the chassis in order to be able to determine the horizontal orientation angle tF. This reference point 13 should be arranged at the greatest possible distance from the scanner in order to attain the best possible precision for the orientation angle tF.

It is important in the case of the exemplary embodiment that the scanner 11 now generates a measuring beam 15 which in the case of rotation of the scanner mirror around the scanner axis 21 by 360° scans a plane in space. In the next step the scanner axis is altered by a predetermined angle and the measuring beam 15 scans the next plane. The following planes complement each other and this operation is continued until the 3D space to be detected is covered.

The measuring beams 15, 16, 17 shown as examples in FIG. 2 are only schematic sectional views of the operation described above.

It is important that the scanner now emit these measuring beams 15-17 to all sides so that it is not important that the reference points 4, 5, 10, 13 detected by the measuring beams 15-17 are before, next to or above the container 3 or are located behind the scanner viewed from the container.

Thus they can be arranged distributed anywhere and in any way in space.

In this connection it is preferred if the spatial reference points 4, 5, 10 are arranged removed from the container 3 in order to bring these reference points outside of the area of contamination of the container 3.

The inclination of all succeeding planes of the measuring beams 15, 16, 17 is detected by an allocated angle sensor in the scanner and included in the measurement.

Important in other respects in the case of the measuring method according to FIG. 2 is that with the detection of the reference points 4, 5 and 10 simultaneously also the complete container 3 is scanned in order in this way to detect the complete inner surface of the container. Further it is advantageous if the reference points are arranged in a spatial region which is located, related to the scanner position, central-symmetric to the region of the container to be measured.

In a preferred embodiment of the present invention the scanner sensor consists of an infrared transmitter and receiver which transmits pulsed infrared signals and receives corresponding echo signals and detects them.

However the invention is not restricted to this. All transmitting and receiving measuring instruments can be used, in particular laser pulse instruments or even instruments which work in other frequency ranges, in particular in the ultraviolet, infrared or also in the visible range.

In FIG. 3 the scanner is shown with its scanner coordinate system. The scanner 11 can be revolved around two axes 21, 22 vertical to one another. With the nearly horizontal axis 22 the angle of inclination Phi is determined, while with the axis 21, which is vertical to axis 22 (rotational axis of the mirror) the scan angle Lambda is determined.

Since the mirror can be located above the point of intersection 25 of the two axes 21, 22 the associated excentricity 19 is mathematically balanced.

In FIG. 3 the scanner and with it the scanner axis 21 is shown in the starting position. A third axis 20 is defined, which normally stands on axes 21 and 22. These axes 20, 21 and 22 constitute the scanner coordinate system. Since the axis 21 is not necessarily perpendicular in the starting position of the scanner, thus is not necessarily located on a radial beam to the center of the earth, this misalignment must be compensated. Thus a reference to a perpendicular euclidean three-dimensional coordinate system whose origin coincides with the origin of the scanner coordinate system is to be made. This takes place by rotation of the axes 22 and 10 on a horizontal plane. In the initial position of the scanner thus the inclination of the axis 22 opposite a horizontal plane defines the angle of inclination AlphaX and the inclination of the axis 20 opposite a horizontal plane defines the angle of inclination Phi0. This perpendicular euclidean coordinate system represents the scanner plumb system.

The following data is detected with a scanner relative to the scanner position and the scanner coordinate system in the surrounding 3D space for each measuring point:

1. Scan distance (distance scanner mirror to area of reflection)
2. Scan reflectivity (echo)=intensity
3. Angle of inclination Phi around a (nearly) horizontal axis 22
4. Scan angle Lambda around an axis 21 orthogonal to axis 22
5. AlphaX and Phi0 angles of inclination of the scanner coordinate system

The resolution of the angle of inclination Phi and of the scan angle Lambda determines the density of the possible data acquisition.

With the detection of the scan reflectivity (intensity of the echo signal) so-called gray scale images can be produced and corresponding to the density of the gray scale image hence very precise contour determinations of objects in space can be performed. The detection of the scan reflectivity is thus an additional item of information for the evaluation of the grid image obtained later. Hence the reference points 4, 5, 10, 13 designed as spheres are detected by pattern recognition in a screened gray scale image of the scanner. The gray scales in this gray scale image can represent the scan reflectivity or the scan distance.

With the help of the scan data (s, Phi, Lambda) and inclination data (Phi0, AlphaX) the coordinates of the area of reflection corresponding to the individual scan points are calculated in the scanner plumb system by means of correlations of analytical geometry. Hence the three coordinates are also present for every reference point in the scanner plumb system.

For the pattern recognition of the reference points designed as spheres for example for all scan points first the values for the coordinates Phi, Lambda and s in the scanner coordinate system are converted to the corresponding values Phi′, Lambda′ and s′ in the scanner plumb system. The s′ values are subsequently prepared as gray scale values in a regular Phi′-Lambda′-grid representing the entire scanned space. Via an edge recognition program all edges are determined in this grid image as well as the standards (with predefined length) to the central points of these edges being calculated. For those sections from the Phi′-Lambda′-grid image with a high number per grid element of points of intersection of the calculated standards the distance to the surrounding edge central points per grid element is calculated as well as a frequency distribution of these distances being determined. The grid elements with the greatest accumulation of a distance in the value range resulting for the grid element are selected. For these selected grid elements in the scanner plumb system the three-dimensional coordinates of the associated scan objects are then determined. In consideration of the known radii of the spheres of the reference points these determined coordinates then correspond to the coordinates of the recognized circle central points in the scanner plumb system. If the detection of the reference points occurs from predefined positions of the measuring or repair device, the conversion of the scan points from the scanner coordinate system to the scanner plumb system as well as the application of the edge recognition program do not need to take place in the entire scanned space but rather only in selected (predefined) regions thereof.

In FIG. 4 the correlation between the horizontal axes xL and yL of the scanner plumb system to the horizontal axes X and Y of the reference system is shown. From a mathematical standpoint the correlation is a two-dimensional coordinate transformation. This can for example take place by means of the application of the displacements dx and dy as well as the rotation tL around the Z axis to the coordinates of all detected reference points in the scanner plumb system, so that these optimally arrive with the coordinates of the same reference points in the reference coordinate system for coincidence. If there are more than 2 reference points present, the precision of the allocation can be determined from them. These displacements dx and dy consequently also represent the X and Y coordinates of the scanner position in the reference system. The Z coordinate of the scanner position in the reference system is given as the difference between the Z coordinates of a reference point in the reference system and the z coordinates (axis intercept on the perpendicular axis) of the same reference point in the scanner plumb system. In the case of the use of more than one reference point the mean can taken from the obtained differences and the precision of the Z coordinate of the scanner position can also be calculated therewith. Hence both the correlation between scanner coordinate system and scanner plumb system as well as the correlation between scanner plumb system and reference system are created.

The measuring operation for the detection of the reference points and of the interior of the fusion melting pot proceeds for example according to the following pattern, wherein with regard to the identification of the reference points two methods are applied:

In the case of predefined positions for the measuring device (Method 1) it is the following steps:
1.) Positioning of the measuring van with the scanner before the container approximately at a predefined position (+/−1 m) at a distance of e.g. 2-10 m and in a horizontal alignment (+/−5°), wherein the data of the predefined positions is stored in the system.
2.) Selection of this approximation position on the system and simultaneous starting of the scan operation in the preset scan range and scan resolution
3.) Storage of the scan data and of the measured inclination angles AlphaX and Phi0 of axes 22 and 20 opposite a horizontal plane.
4.) Sequential calculation of inclination angles Phi, scan angle Lambda and distance to each reference point 4, 5, 10 with the help of the approximate position, approximation orientation and the known coordinates of the respective reference point.
5.) Detection of the sphere central points of the reference points 4, 5, 10 by pattern recognition in the digital acquisition screen.
6.) Calculation of the local coordinates in the scanner plumb system for each reference point.
7.) Calculation of the scanner position in the reference system with the help of coordinates of the reference points in the scanner plumb system and reference system.
8.) Scanning of the interior of the metallurgical container with the same scanner from the same position of the scanner as in the case of the detection of the reference points.

It is also emphasized that the measurement of the interior of the metallurgical container 3 can also take place in the same scan operation as the measurement of the location of the reference points 4, 5, 10 in space. Simultaneously the angles Phi0 and AlphaX as well as the pivoting angle of the container are also detected. With this it is very easy to also perform a measurement position deviating from a central measurement position by for example placing the scanner 11 on the chassis 12 in a measuring position offset to the left or to the right.

Also in the case of a measurement performed from an offset position in accordance with FIG. 2 both the interior of the container 3 as well as the location of all reference points 4, 5, 10 in space and the inclination angle and the pivoting angle are detected.

In a second preferred embodiment of the present invention an automatic point identification of the reference points 4, 5, 10 takes place according to the following pattern (Method 2):

1.) Random positioning of the measuring van in the region in which the reference points 4, 5, and the interior of the container can be detected
2.) Starting of the scan operation in the preset scan range and scan resolution.
3.) Storage of scan data and of the measured inclination angles AlphaX and Phi0 of axes 22 and 20 opposite a horizontal plane.
4.) Location of all spheres in the scan range and detection of the sphere central points.
5.) Calculation of the local coordinates of the sphere central points in the scanner plumb system for each detected sphere.
6.) Identification of the reference points 4, 5, 10 (e.g. via analysis of the inner geometry of the reference points)
7.) Calculation of the scanner position in the reference system with the help of coordinates of the identified reference points 4, 5, 10 in the scanner plumb system and in the reference system.
8.) Scanning of the interior, as described in Method 1.

For identification of the reference points via an analysis of the inner geometry it is for example necessary to compile a List A of all possible triangles from the known reference points in the reference system. Along with the designation of the three respective reference points this List A contains the three horizontal line segments, the height differences as well as a triangle factor determined via a random function from the horizontal line segments and the height differences. Also a List B of all possible triangles is to be created from the scan objects detected in scanning in the scanner plumb system. Along with the designation of the respective scan objects this List B contains the associated horizontal line segments, the height differences and the triangle factors. If the same triangle factors are found in List A and List B and verified with the help of the associated horizontal line segments and height differences, the scan objects from List B corresponding to the reference points from List A can be found and in this way an allocation of the designation of the reference points to the scan objects can take place.

The connection created between the scanner coordinate system and the reference system (this is the space in which the container is set up and its axis of tilt measured) via knowledge of the inclination angle AlphaX and the detection and localization of the reference points can now be used in order to transform the scan points measured at the inner lining to the reference system. The knowledge of the coordinates of the container as well as its pivoting angle in turn makes possible a transformation of these points measured at the inner surface of the container to a coordinate system orientated on the container. In order to guarantee also the comparability or completion of the results from the various measurements of the same metallurgical container, the results, as shown in FIG. 5a, are stored in a regular grid. This grid is built at a developed view of the inner surface of the container on a virtual plane with the coordinates m and n. The individual scan points 26, which are present in irregular form on the container inner surface as well as the distances calculated for these points from the selected reference plane are allocated to the associated grid elements. For example, the measured inside of the steel jacket or also the geometry of the inside of the steel jacket taken from a drawing of the container can serve as reference plane. Per grid element an average of the distances allocated to the respective scan points is taken via weight algorithms and these results can then be converted to corresponding gray scales or color scales (FIG. 5b).

Depending on the selection of the reference plane and the operating state of the metallurgical container the distances calculated per grid element then result in the wall thickness of the lining (lining thickness, residual thickness) or the wear and tear of the lining.

In FIG. 6 for example a wear and tear image in the form of a grid image of the developed view of the inner surface area of a metallurgical container is shown. Each single grid field can contain zero, one or several scan points. The value of the residual thickness of the layer of wear and tear allocated to each grid field can thus be determined from the data of the scan points allocated to the grid field.

The residual thickness of the layer of wear and tear is shown in the form of gray scales or in a color-coded display. In this connection a measurement of an inner lining with no wear and tear and known thickness of the lining or of a measurement of the inside of the permanent lining or of the steel jacket is assumed and the values determined in the process are compared with the current measuring results of a layer of wear and tear. The resulting residual thicknesses per grid field of the layer of wear in tear are reproduced in gray scales or in a color code. However the data taken from a drawing of the fusion pot can also be used as a starting point for the reference plane.

In a different embodiment provision is made to display what has already been worn through wear and tear.

Especially worn regions are then displayed in color for example with the color yellow or orange in order in this way to give a rapid overview of the wear and tear of the inner lining of the metallurgical container.

An application of the invention for the detection of the position and orientation of a repair device or the like is schematically represented in FIG. 7. In this application case, as already mentioned earlier, an additional reference point 13 firmly connected to the repair device or to the associated carrier plate 14 is required. With this the direction of this carrier plate and of the chassis 12 connected to it or of the repair device to the container 3 can be determined. This is the foundation for the use of an automated repair device, whose position and orientation in relation to the container must be uniquely known.

For the carrying out of this method a euclidean vehicle coordinate system or a coordinate system of the repair device with the axes xF (longitudinal axis of the carrier plate), yF (vertical to the longitudinal axis and on the plane of the carrier plate) and zF (axis vertical to xF and yF and beginning in its point of intersection) is defined with relation to the carrier plate 14.

With regard to this vehicle coordinate system the coordinates of the scanner (origin of the scanner coordinate system) and the coordinates of the reference point 13 are measured once and with that assumed as known for the selected arrangement.

The inclination angle of the axes xF and yF of the vehicle coordinate system against a horizontal plane are determined by means of inclination sensors (inclination angles AlphaXF and Phi0F). For the special case that the axes xF and yF of the vehicle coordinate system each lie parallel to the corresponding axes x (20) and y (22) of the scanner coordinate system, AlphaXF=AlphaX and Phi0F=Phi0.

Further in FIG. 7 the connection between the vehicle coordinate system and the reference system is shown. In the process it is to be noted that the display already shows the intermediary step according to sequential rotation of the axes xF and yF of the vehicle coordinate system around the axes yF or xF on a horizontal plane. These axes after rotation are marked as xFL and yFL. The orientation angle tF is hence defined as a horizontal angle between the xF axis of the vehicle coordinate system (=axis xFL) rotated on a horizontal plane and the X axis of the reference system.

The determination of tF takes place in the process by initiation of a transformation of the coordinates of the scanner position and of the reference point 13 of the reference system to the vehicle coordinate system in consideration of
calculated coordinates of the scanner position and position of the reference point 13 in the reference system
knowledge of the coordinates of the scanner position and position of the reference point 13 in the vehicle coordinate system
measurement of the inclination angle AlphaXF and Phi0F of the axes xF and yF against a horizontal plane

With this a unique reference of the vehicle coordinate system is made to the reference system and hence to the repairing vehicle.

For a repair of the inner lining of the container 3 it is then sufficient to arrange for example a robot repair system on the chassis 12 firmly connected to the carrier plate in which case by means of a feed system a lance is fed in a controlled manner into the interior of the container in order to perform the appropriate wear and tear repair at the places ascertained by the measuring system.

The measuring sequence for the detection of position and orientation of a repair device is as follows in the case of usage of predefined positions:

1.) Positioning of the measuring/repair device with the scanner before the container approximately at a predefined position (+/−1 m) and in a horizontal alignment (+/−5°), wherein the data of the predefined positions is stored in the system.
2.) Selection of this approximation position on the system and simultaneously starting of the scan operation in the preset scan range and scan resolution
3.) Storage of the scan data, the measured inclination angles AlphaX and Phi0 of axes 22 and 20 opposite a horizontal plane and of the measured inclination angle AlphaX and Phi0F of the axes xF and yF opposite a horizontal plane.
4.) Sequential calculation of inclination angles Phi, scan angle Lambda and distance to each reference point 4, 5, 10, 13 with the help of the approximate position, approximation orientation and the known coordinates of reference points 4, 5, 10.
5.) Detection of the sphere central points of the reference points 4, 5, 10, 13 by pattern recognition in the digital acquisition screen.
6.) Calculation of the local coordinates in the scanner plumb system for each reference point.
7.) Calculation of the scanner position in the reference system with the help of coordinates of the reference points in the scanner system and reference system.
8.) Calculation of the orientation angle tF of the repair device or of the vehicle coordinate system via the scanner position and the calculated coordinates of the reference point 13 at the repair device or the carrier plate in the reference system, the scanner position and coordinates of the reference point 13 in the vehicle coordinate system, Alpha XF and Phi0F.

As an alternative here instead of the predefined positions for the measuring/repair device a random position can also be selected and the automatic identification of the reference points 4, 5, 10 similar to Method 2 of the detection of the reference points and the interior of the fusion pot can be applied.

With knowledge of the position and orientation of the repair vehicle 12 and of the carrier plate 14 connected therewith in relation to the container 3 a feedable lance controlled from the repair vehicle can be fed into the interior of the metallurgical container and in preprogrammed manner rotated, swiveled or positioned in another way. This positioning is detected via sensors which make the reference to the vehicle coordinate system. In this way an automatic, completely autonomous running repair of wear and tear layers is possible in the interior of the metallurgical container.

In this connection the data of the measured wear and tear regions is passed to the repair vehicle and the repair robot fastened to it and the repair robot is controlled with this data and the data about the position and orientation of the carrier plate of the repair vehicle.

In this connection it is not necessary to the solution that the repair robot be arranged on a self-propelled vehicle. It is also possible to arrange such a repair robot stationary on a rack in the access region of the metallurgical container in order in this way to perform an automatic repair in the interior of the container by controlled axis and feed motions.

The invention is in other respects not restricted to the application of a single scanner. A single scanner is only necessary when the actual state of a metallurgical container is to be detected and if necessary compared to a target state.

If on the other hand the lining of a metallurgical container is to be repaired, provision can be made for a first scanner for the measurement of the actual state and a second scanner can be provided for the determination of the position and orientation of the repair device or the associated carrier plate 14.

It is also sufficient to execute the measuring operation and the detection of the position and the orientation of the repair device with a single scanner. The measuring detection and the repair device would then be on a single vehicle.

It is also possible to use a common stationary device instead of a vehicle.

If it is determined in the case of the detection of position and orientation of the repair device that to achieve an optimal driving style of the repair robot a correction of the spatial positioning of the carrier plate is necessary, this correction will be automatically carried out within constructive predefined limits. The optimal driving style of the repair robot is given when said robot must only execute the simplest possible pattern of movement during the repair operation, complex sequences of movements and idling positions must be avoided and as a result the shortest possible repair times can be achieved. If the necessary correction lies outside the predefined limits, the repair device is to be driven to a more favorable position for the execution of the repair. After performance of this automatic correction of the position of the carrier plate or of this manual repositioning of the repair device the determination of position and orientation of the repair device and of the vehicle coordinate system in relation to the reference system takes place in turn as just now described.

### DRAWING LEGEND

1 Measuring fixed point
2 Measuring fixed point
3 Container
4 Reference point
5 Reference point
6 Axis of tilt point
7 Axis of tilt point
8 Axis of tilt
9, Pivoting angle of the fusion pot
10 Reference point
11 Scanner
12 Chassis
13 Reference point
14 Carrier plate
15 Measuring beam
16 Measuring beam
17 Measuring beam
18
19 Excentricity
20 Axis (vertical to 21 and 22)
21 Scanner axis
22 Inclination axis of the scanner
23 Perpendicular axis
24
25 Origin of the scanner coordinate system and scanner plumb system
26 Individual scan point
27 Grid element

1. A method for the determination of the wall thickness or of the wear and tear of the lining of a metallurgical fusion pot with a scanner system for contactless detection of the lining area with determination of the position and orientation of the scanner system and allocation to the position of the fusion pot by the detection of spatial reference points, characterized by the following procedural steps:
1. Definition of a space coordinate system as a reference system by means of at least two measuring fixed points
2. Definition of at least two spatial reference points in the reference system and measuring of these reference points with known geodetic methods
3. Designing of the reference points as sphere areas
4. Measurement of the coordinates of at least two points of the horizontal or rotational axis of the involved metallurgical container in the reference system with known geodetic methods
5. Definition of a grid system on the developed view of the theoretical interior of the container lining
6. Scanning of the spatial reference points with a three-dimensional scanner (radiation emitting and receiving measuring instrument).
7. Determination of the scanner position in the reference system
8. prior, simultaneous or subsequent scanning of the inner wall of the metallurgical container with the same scanner in the same scanner position as in the case of scanning of the spatial reference points
9. Detection of the pivoting angle of the fusion pot
10. Calculation of the coordinates of each scan point of the interior of the lining in the reference system and allocation of the scan point to a grid element in the grid system defined in Step 5
11. Determination per grid element of a wall thickness or of the wear and tear of the lining using the coordinates of the allocated scan points and coordinates of randomly selectable reference data
12. Representation of the determined wall thickness or of the wear and tear in the grid system

2. The method according to claim 1, characterized in that in the first procedural step the aforementioned measurement of a central position of the scanner with regard to the mouthpiece of the metallurgical container takes place and that in a further procedural step a measuring position offset from the center either to the left or to the right is taken and in this connection in turn the measuring method according to the above named procedural steps is performed.

3. A method for the operation of a repair device for the repair of the layer of wear and tear of metallurgical containers using a scanner system, wherein the determination of the position and orientation of the repair device and allocation to the position of the metallurgical container take place by the detection of spatial reference points, characterized by the following procedural steps
1. Definition of a space coordinate system as a reference system by means of at least two measuring fixed points
2. Definition of at least two spatial reference points in the reference system and measuring of these reference points with known geodetic methods
3. Measurement of the coordinates of at least two points of the horizontal or rotational axis of the involved metallurgical container in the reference system with known geodetic methods
4. Definition of a coordinate system of the repair device as a three-dimensional euclidean coordinate system
5. Definition of a reference point on the carrier plate and measurement of this reference point and position of the scanner in the coordinate system of the repair device
6. Scanning of the spatial reference points and of the reference point fixed on the carrier plate with a three-dimensional scanner mounted on the carrier plate (radiation emitting and receiving measuring instrument).
7. Measuring of the inclination of the coordinate system around the xF or yF axis with regard to a horizontal plane by means of inclination sensors
8. Determination of the scanner position and coordinates of the reference point fixed on the carrier plate in the reference system and from this determination of the orientation angle tF of the repair device in the reference system
9. Preparation of the reference of the coordinate system of the repair device to the fusion pot in consideration of the measured inclinations as per Step 7 and of the pivoting angle of the fusion pot.

4. The method according to claim 1, characterized in that the stationary reference points are arranged removed from the container outside of the area of contamination.

5. The method according to claim 1, characterized in that the reduction to at least two spatial reference points is possible as a result of the fact that a perpendicular reference system is used and the inclinations of two axes of the scanner coordinate system with regard to a horizontal plane are measured by means of inclination sensors.

6. The method according to claim 1, characterized in that at least two stationary reference points are located in the measuring range of the scanner and the scanner works as a rotating scanner with angular coverage of more than 300 degrees.

7. The method according to claim 1, characterized in that the position (X, Y, Z) of the 3D scanner are measured or calculated in a euclidean, perpendicular, three-dimensional coordinate system as well as the horizontal angle between xL-axis of the scanner plumb system and X-axis of the coordinate system (orientation angle tL).

8. The method according to claim 7, characterized in that in addition to the position of the scanner and the longitudinal and lateral inclination of the scanner and of a carrier plate of a repair device in reference to the horizontal plane of a euclidean perpendicular three-dimensional coordinate system (reference system) also the horizontal angle between the horizontal longitudinal axis xF of this carrier plate rotated in the horizontal plane and the X-axis of the reference system (orientation angle tF) can be measured or calculated.

9. The method according to claim 1, characterized in that the following measuring results are detected:
1. Coordinates of the origin of the scanner plumb system of a scanner (on the measuring device or the carrier plate of a repair device) in a reference system
2. Inclination of the scanner coordinate system in relation to the scanner plumb system (AlphaX and Phi0 angles)
3. Inclination of the vehicle coordinate system around the xF axis with regard to a horizontal plane (AlphaXF)
4. Inclination of the vehicle coordinate system around the yF axis with regard to a horizontal plane (Phi0F)
5. Orientation angle tL and tF
6. Pivoting angle of the fusion pot.

10. The method according to claim 1, characterized in that all measuring results are optionally detected in one of the following coordinate systems:
1. a perpendicular, three-dimensional coordinate system or
2. a polar coordinate system or
3. a cylinder coordinate system.

11. The method according to claim 1, characterized in that along with the fixing of the stationary and precisely defined measuring fixed points also the spatial coordinates of the container (axis of tilt points 6, 7) and of the reference points are detected.

12. The method according to claim 1, characterized in that the reference points designed as spheres are detected by pattern recognition in a screened gray scale image of the scanner.

13. A device for determining the position of measuring and/or repair systems for the lining of metallurgical containers with a scanner system for contactless detection of the lining area, wherein the determination of the position and orientation of the measuring system and/or repair system and allocation to the position of the metallurgical container take place by the detection of spatial reference points, characterized in that the measurement takes place with a 3D scanner and that the spatial reference points or reference points arranged on the carrier plate are designed as sphere areas.

14. The device for the carrying out of a method according to claim 1, characterized in that the scanner and an additional vehicle-side reference point are fastened to a carrier plate which is mounted to a chassis.

15. The device for the carrying out of a method according to claim 1, characterized in that the stationary reference points are arranged in a spatial region which is located, related to the scanner position, central-symmetric to the region of the container to be measured or repaired.

16. The device according to claim 14, characterized in that a robot repair system is arranged on the chassis, in which case by means of a feed system a lance is fed in a controlled manner into the interior of the container in order to perform the appropriate wear and tear repair at the places ascertained by the measuring system.

17. The device for the carrying out of a method according to claim 1, characterized in that the following data is detected with the scanner of the scanner position in the surrounding 3D space for each measuring point:
1. Scan distance (distance scanner mirror to area of reflection)
2. Scan reflectivity (echo)=intensity
3. Angle of inclination Phi around a (nearly) horizontal axis 22
4. Scan angle Lambda around an axis 21 orthogonal to axis 22
5. AlphaX and Phi0 angles of inclination of the scanner coordinate system

18. The device for the carrying out of a method according to claim 1, characterized in that the reference points designed as spheres are detected by a pattern recognition in a screened gray scale image of the scanner.

19. The method according to claim 2, characterized in that the stationary reference points are arranged removed from the container outside of the area of contamination.

20. The method according to claim 3, characterized in that the stationary reference points are arranged removed from the container outside of the area of contamination.
